(19) United States
(12) Patent Application Publication
(10) Pub. No.: US 2010/0019025 A1
(43) Pub. Date: Jan. 28, 2010

(54) MOBILE SELLING SYSTEM AND A METHOD THEREOF

(76) Inventors: Fa-Yu Wang, Taichung City (TW); Yen-Ming Chu, Taichung City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/178,057

(22) Filed: Jul. 23, 2008

(51) Int. Cl. G06F 17/00

(52) U.S. Cl. 235/375

(57) ABSTRACT

In a mobile selling system and method, a server at a business control center is able to identify a plurality of mobile POS by a unique identification code assigned to each of the mobile POS, and provide the mobile POS with sales information corresponding to a district assigned to the mobile POS; the mobile POS each generates a mobile data when moving to a different position, and transmits the mobile data via a communication interface module thereof to the server in the form of a wireless signal; the server identifies the mobile POS according to the identification code corresponding to the received mobile data, reads out sales information corresponding to the identification code of the mobile POS, and provides the sales information to the mobile POS; and the mobile POS receives the sales information via the communication interface module and shows the sales information via a display unit.

### FIELD OF THE INVENTION

The present invention relates to a mobile selling system and a method thereof, and more particularly to a mobile selling system and method in which a server at a business control center is able to identify a plurality of mobile points of sale (POS) and provide each of the mobile POS with sales information corresponding to a marketing district assigned to the mobile POS.

### BACKGROUND OF THE INVENTION

With the prosperously developed commercial and industrial society, a large number of people have engaged in the marketing of different products. Currently, a salesman has to carry the products, samples, and/or catalogues thereof with him when visiting customers. These products, samples, and catalogues form a burden and bring inconveniences to the salesman when traveling outdoors. On the other hand, a manager in the company could hardly control the selling condition and the selling district of the salesman.

For example, a company may simply assign a district A to a salesman for marketing. However, for the purpose of promoting business and earning more money, the salesman might break the rules of the company to sell products in an area beyond the assigned district A to thereby cause serious loss to another salesman and even lead to conflicts among different salesmen.

Moreover, the salesman does not always achieve the target sales amount or quantity. For example, the salesman's target sale this month is 50 cell phones, 10 suites, and 20 cosmetic items. However, at the end of the month, it comes out only 49 cell phones, 1 suite, and 15 cosmetic items are sold. The company might fail to know this poor selling condition and still provides the salesman with different products in the same quantities as before for selling in the next month. In this case, it is very possible the unsold products are accumulated to form an invisible burden to the company. That is, since the company fails to effectively manage and control the salesman's selling condition, the marketing efficiency is low.

In brief, the following disadvantages are found in the conventional way of marketing:
1. There is not an effective way for restricting the salesman from selling products in an unauthorized district.
2. The manager in the company could not effectively control the salesman's selling condition.

It is therefore tried by the inventor to develop a mobile selling system and method to overcome the disadvantages in the conventional marketing manner.

### SUMMARY OF THE INVENTION

A primary object of the present invention is to provide a mobile selling system and a method thereof, in which a server at a business control center is able to identify a plurality of mobile POS and provide the mobile POS with sales information corresponding to a district assigned to each of the mobile POS for marketing, so as to manage selling condition and restrict a salesman from selling products beyond the district assigned to the salesman.

To achieve the above and other objects, the mobile selling system according to the present invention includes a server at a business control center and a plurality of mobile POS. The server is able to identify each of the mobile POS and provide the mobile POS with sales information corresponding to a district assigned to each of the mobile POS. Each of the mobile POS includes a display unit for showing the sales information; a communication interface module wirelessly linked to the server for receiving the sales information; an assisted global positioning system (AGPS) module for receiving a satellite signal transmitted from a satellite, and receiving an auxiliary positioning data generated by a relay base, which receives, computes, and processes a wireless signal transmitted from a wireless transceiver of the AGPS module to generate the auxiliary positioning data; and a processing unit coupled with the communication interface module, the AGPS module, and the display unit for receiving and computing the satellite signal to generate a mobile data for use in managing the selling condition and restricting the salesman from marketing beyond the assigned district.

The mobile selling method according to the present invention includes the following steps: a server at a business control center identifies a plurality of mobile POS by a unique identification code assigned to each of the mobile POS and provides the mobile POS with sales information corresponding to a marketing district assigned to the mobile POS; each of the mobile POS generates a mobile data when moving to a different position, and transmits the mobile data via a communication interface module thereof to the server in the form of a wireless signal; the server identifies each of the mobile POS according to the identification code corresponding to the received mobile data, reads out sales information corresponding to the identification code assigned to the mobile POS, and provides the sales information to the mobile POS; and the mobile POS receives the sales information via the communication interface modules and shows the received sales information via a display unit thereof. As a result, it is possible to manage the selling condition and restrict the salesman from marketing beyond the assigned district.

The mobile selling method according to the present invention also includes the steps for controlling the selling activities of a salesman. The steps include: wirelessly linking a plurality of mobile POS to a server at a business control center; each of the mobile POS presetting a target sale parameter at the server, and the preset target sale parameter being valid only for a predetermined period of time; when the time is over, the server summing to obtain an actual sale parameter achieved by the mobile POS within the predetermined period of time, comparing the actual sale parameter with the target sale parameter, computing the comparison to obtain a result, and giving the mobile POS a new credit value based on the computed result.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 schematically shows the framework of a mobile selling system according to the present invention;

FIG. 2A is a block diagram of a mobile POS in the mobile selling system of the present invention;

FIG. 2B is a block diagram of a server at a business control center for the mobile selling system of the present invention;

FIG. 3 is a flowchart showing the steps included in a mobile selling method according to the present invention; and

FIG. 4 is a flowchart showing the steps included in the mobile selling method of the present invention for controlling sales activities of the mobile POS.

### DETAILED DESCRIPTION OF THE PREFERRED EMBODIMENTS

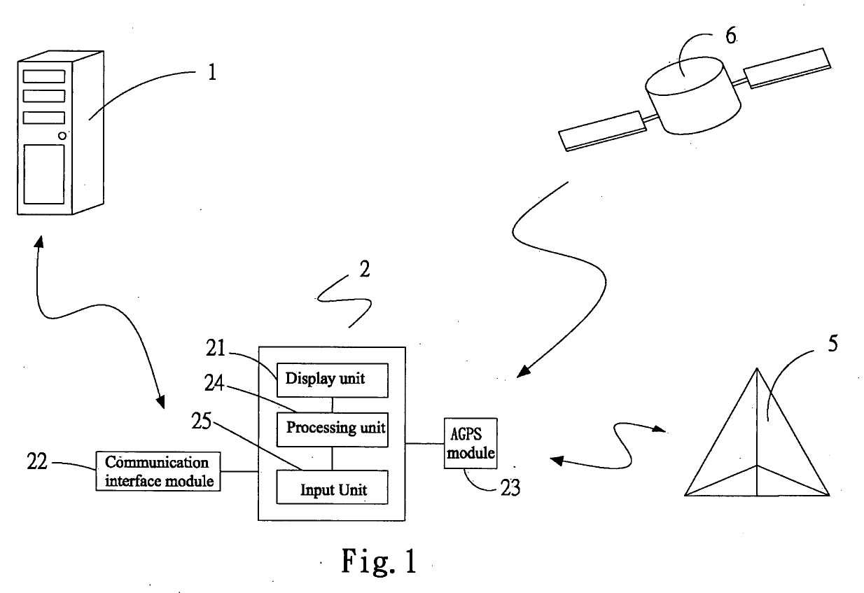

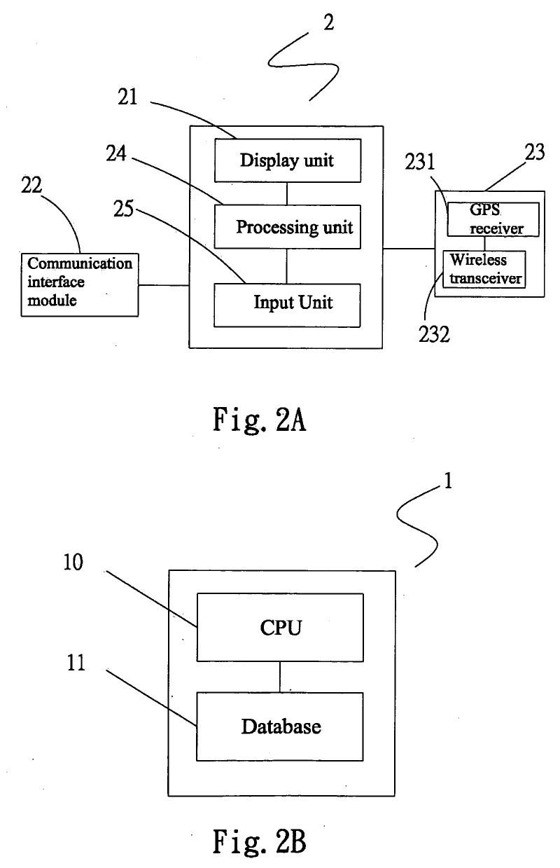

Please refer to FIGS. 1, 2A, and 2B. In a mobile selling system according to a preferred embodiment of the present invention, there is included a server at a business control center 1 and a plurality of mobile points of sale (POS) 2. Each of the mobile POS 2 has a unique identification code (such as a serial number of the mobile POS) assigned thereto. By means of the identification code, the server 1 is able to identify each of the mobile POS 2 and provide the mobile POS 2 with sales information corresponding to a marketing district assigned to that mobile POS 2. Each of the mobile POS 2 includes a display unit 21, a communication interface module 22, an assisted global positioning system (AGPS) module 23, and a processing unit 24. The display unit 21 is coupled with the processing unit 24, and the processing unit 24 is further coupled with the communication interface module 22 and the AGPS module 23.

The display unit 21 may be a touch panel to provide display and control-by-touch functions. Sales information received from the processing unit 24 may be shown on the display unit 21. It is understood the display unit 21 is not limited to a touch panel but may be any other functionally equivalent display panel. The communication interface module 22 is wirelessly linked to the server 1 via a wireless network, for example, for receiving sales information transmitted from the server 1 and then transferring the received sales information to the processing unit 24. The AGPS module 23 receives a satellite signal transmitted from a satellite 6. In case of a weak or poor satellite signal, a wireless transceiver 232 of the AGPS module 23 generates a wireless signal to a relay base 5. The relay base 5 computes and processes the received wireless signal to produce a positioning data as an auxiliary means for positioning the mobile POS 2. Then the relay base 5 transmits the positioning data to the AGPS module 23 to help in positioning the mobile POS 2.

The wireless signal from the AGPS module 23 contains data transmitted via the satellite signals, such as the geographic longitude and latitude coordinates, the current time, and the speed of the mobile POS 2. The above-mentioned positioning data includes the geographic longitude and latitude coordinates, the current time, and the speed of the mobile POS 2 having been computed and processed by the relay base 5. The processing unit 24 receives the satellite signals transmitted to the AGPS module 23 and conducts computation and processing on the received satellite signals to generate a mobile data, including the geographic longitude and latitude coordinates, the current time, the speed, and the identification code of the mobile POS 2.

When a salesman carrying the mobile POS 2 goes to the assigned district for marketing, the AGPS module 23 of the mobile. POS 2 constantly receives satellite signals transmitted from a satellite 6. In case of a weak or poor satellite signal, the wireless transceiver 232 of the AGPS module 23 generates a wireless signal to the relay base 5. The relay base 5 computes and processes the received wireless signal to generate the auxiliary positioning data. Then, the relay base 5 transmits the positioning data back to the wireless transceiver 232, so that the AGPS module 23 may locate the position of the mobile. POS 2 via the auxiliary positioning data received by the wireless transceiver 232 and transmit the satellite signal to the processing unit 24. The processing unit 24 computes and processes the received satellite signal to generate the above-mentioned mobile data, which is then transmitted via the communication interface module 22 to the server 1 in the form of a wireless signal.

The server 1 determines based on the identification code of the mobile POS 2 whether the wireless signal sent thereto is a mobile data. If yes, the server 1 follows the identification code corresponding to the received mobile data to provide and transmit the above-mentioned sales information to the communication interface module 22, so that the processing unit 24 receives the sales information via the communication interface module 22 and transmits the sales information to the display unit 21 to show the sales information in connection with the assigned district. With these arrangements, it is possible to manage the salesman's selling condition and restrict the salesman from selling products beyond the assigned marketing district.

Please refer to FIGS. 1, 2A, and 2B. The server 1 includes a central processing unit 10 and a database 11 electrically connected to the central processing unit 10. The database 11 is internally divided into a plurality of data fields, each of which has at least one sub-field. For example, the sub-fields may include, but not limited to, type of product, target sales quantity, target sales amount, actual transaction quantity, actual transaction amount, profit, selling district, etc.

The central processing unit 10 computes and processes the data in the database 11 and selectively restricts the authority of the mobile POS 2 to access the data in the sub-fields of the data fields according to a credit value given to the mobile POS 2. According to the credit value given to the mobile POS 2, the central processing unit 10 adjusts the authority of the mobile POS 2 to access the data in the sub-fields. When the mobile POS 2 achieves a target sales quantity or amount previously set and wirelessly transmitted to the server 1, the credit value given to the mobile POS 2 is increased. Reversely, in the event the previously set target sales amount or quantity is not achieved, the credit value given to the mobile POS 2 is decreased.

The relay base 5 may be a base station for receiving, computing, and processing the wireless signal transmitted from the wireless transceiver 232 to generate the above-mentioned auxiliary positioning data. The mobile POS 2 further includes an input unit 25 electrically connected to the processing unit 24. The input unit 25 may be a keyboard, with which the salesman may input the target sales quantity and amount, etc. In addition to the wireless transceiver 232, the above-mentioned AGPS module 23 also includes a global positioning system (GPS) receiver 231 electrically connected to the wireless transceiver 232. The GPS receiver 231 receives the satellite signal transmitted from the satellite 6, and the wireless transceiver 232 transmits wireless signals and receives the auxiliary positioning data generated by the relay base 5.

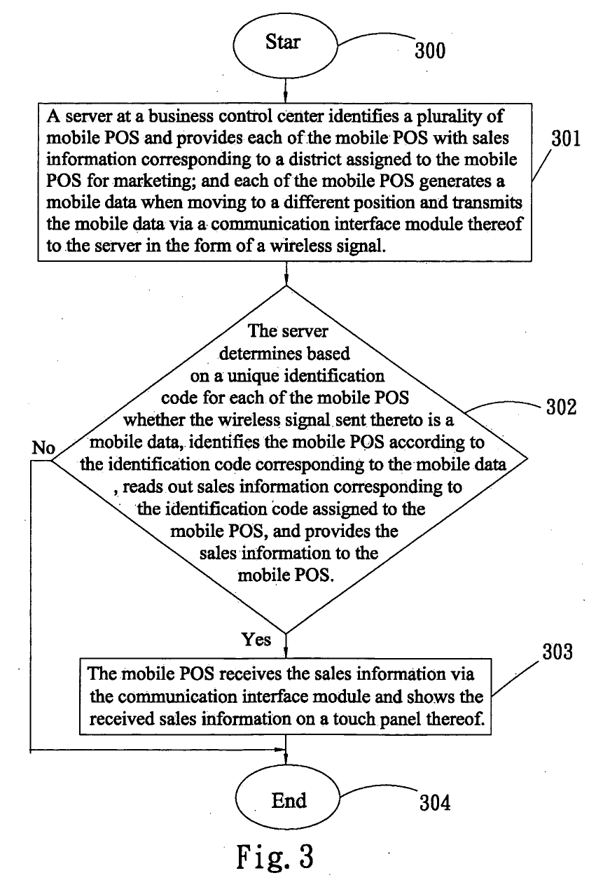

Please refer to FIGS. 1, 2B, and 3. The present invention also provides a method for implementing a mobile selling via the above-described mobile selling system. The steps included in the mobile selling method of the present invention are now described as below.

In a first step 300, the mobile selling starts.

In a second step 301, the server 1 identifies each of the mobile POS 2 by the unique identification code assigned thereto, so as to provide the mobile POS 2 with sales information corresponding to a specific district assigned to the mobile POS 2 for marketing. The AGPS module 23 of each of the mobile POS 2 receives satellite signals while moving to different positions, and transmits the received satellite signals to the processing unit 24 for computing and processing to generate the mobile data, which is then transmitted via the communication interface module 22 to the server 1 in the form of a wireless signal.

In a third step 302, the central processing unit 10 of the server 1 determines based on the identification code of the mobile POS 2 whether the wireless signal sent thereto is a mobile data, identifies the mobile POS 2 according to the identification codes corresponding to the mobile data, reads out sales information corresponding to the identification code assigned to the mobile POS 2, and provides the sales information to the mobile POS 2. When the central processing unit 10 of the server 1 determines the received wireless signal is a mobile data, the method goes to the fourth step 303; or when it is determined the received wireless signal is not a mobile data, the method goes to the fifth step 304.

In the fourth step 303, the mobile POS 2 receives the sales information via the communication interface module 22 and the received sales information is shown on the display unit 21. The sales information may include the time, the districts, the products, and the prices allowed for selling by the mobile POS 2.

In the fifth step 304, the mobile selling is ended.

In brief, the AGPS module 23 of each of the mobile POS 2 receives satellite signals while moving to different positions, and transmits the received satellite signals to the processing unit 24 for computing and processing to generate the mobile data, which is then transmitted via the communication interface module 22 to the server 1 in the form of a wireless signal, so that the central processing unit 10 of the server 1 determines based on the identification code of the mobile POS 2 whether the wireless signal sent thereto is a mobile data. If yes, the central processing unit 10 identifies the mobile POS 2 according to the identification codes corresponding to the mobile data, reads out data in the sub-fields of the data fields (i.e., sales information) corresponding to the identification code assigned to the mobile POS 2, and provides the data in the corresponding sub-fields to the mobile POS 2. Meanwhile, the mobile POS 2 receives the data in the corresponding sub-fields via the communication interface module 22 and the received sub-field data is shown on the display unit 21. As a result, it is possible to manage the salesman's selling condition and restrict the salesman from marketing beyond the assigned district.

Please refer to FIGS. 1, 2B, and 4. The mobile selling method according to the present invention also includes the steps for controlling sales activities of the mobile POS 2. The mobile POS 2 is wirelessly linked to the server 1 to preset a target sale parameter in the server 1. The target sale parameter is valid only for a predetermined period of time. When the time is over, the server 1 will sum the sales amount achieved by the mobile POS 2 during the predetermined period of time to obtain an actual sale parameter, and compares the actual sale parameter with the target sale parameter. After comparison and computation, the server 1 will give the mobile POS 2 a new credit value based on a result from the computation.

In the event the actual sale parameter is equal to or higher than the target sale parameter, the credit value is increased. On the contrary, in the event the actual sale parameter is lower than the target sale parameter, the credit value is decreased. Based on the adjusted credit value, the server 1 decides the sales information available for the mobile POS 2, including the types, the quantities, and the amounts of products allowed for selling, the districts allowed for marketing, etc.

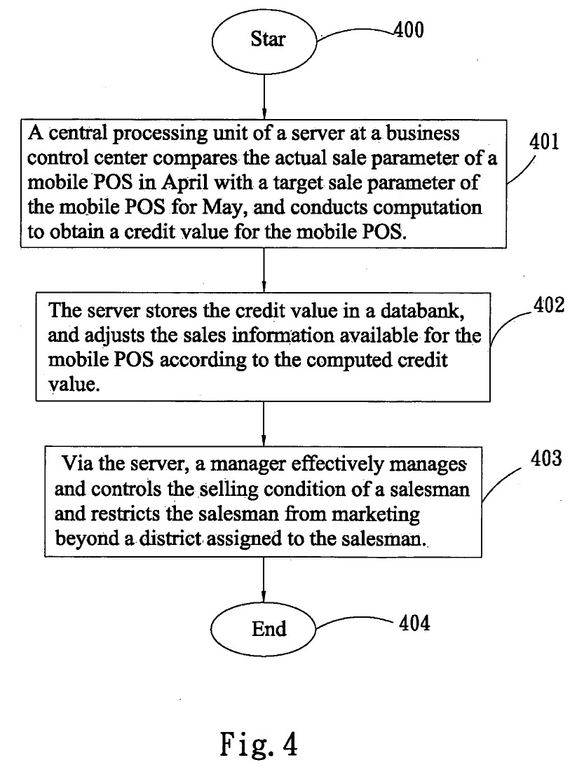

Please refer to FIG. 4 that is a flowchart illustrating the steps included in an example of the mobile selling method of the present invention for controlling the sales activities of the mobile POS 2.

In a first step 400, the mobile selling starts.

In a second step 401, the central processing unit 10 of the server 1 compares the actual sale parameter of the mobile POS 2 achieved in April with the preset target sale parameter for May, and computes to obtain a credit value for the mobile POS 2.

In a third step 402, the server 1 stores the obtained credit value for the mobile POS 2 in the database 11, and adjusts the sales information available for the mobile POS 2 according to the credit value. For example, the target sale parameter preset for May includes 200 cell phones, 50 suites, and 300 pork buns. And, the mobile POS 2 has a credit value of POOR for the cell phones in April. Under this circumstance, the central processing unit 10 will reject the target sale parameter of the mobile POS 2 set for May, and reduces the quantity of cell phones to be 100 pieces and the profit thereof is reduced as a punishment. The central processing unit 10 will also narrow the area within which the mobile POS 2 is allowed to market. Or, if the credit value of the mobile POS 2 for the selling of suites is GOOD in April, the central processing unit 10 will accept the target sale parameter of the mobile POS 2 set for the suites in May and promotes the profit thereof from previous 6% to 12%. The central processing unit 10 will also widen the marketing area allowed for the mobile POS 2. In the event the credit value of the mobile POS 2 for the pork buns in April is BAD, the central processing unit 10 will reject the target sale parameter set by the mobile POS 2 for May and does not allow the mobile POS 2 to sell the pork buns in May.

In the fourth step 403, via the server 1, a manager is able to manage and control the salesman's selling condition and restrict the salesman from marketing beyond the districts particularly assigned to the salesman.

And, in the fifth step 404, the mobile selling is ended.

As can be seen from the above description, the mobile selling system and the method thereof have the following advantages:
1. The salesman is restricted to sell products only in the district particularly assigned to the salesman.
2. The sales activities of the salesman are controlled via credit value given to the salesman.
3. The manager may effectively manage and control the salesman's selling condition via the server at the business control center.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A mobile selling system, comprising a server at a business control center and a plurality of mobile POS, the server being able to identify each of the mobile POS and providing the mobile POS with sales information corresponding to a marketing district assigned to the mobile POS; and each of the mobile POS including:
a display unit for displaying the sales information provided to the mobile POS by the server;
a communication interface module wirelessly linked to the server for receiving the sales information;
an AGPS module for receiving a satellite signal transmitted from a satellite, transmitting a wireless signal via a wireless transceiver of the AGPS module to a relay base for computing and generating a positioning data, and receiving the positioning data from the relay base for use as an auxiliary means to help in positioning the mobile POS; and
a processing unit coupled with the communication interface module, the AGPS module, and the display unit; and the processing unit receiving the satellite signal and computing the received satellite signal to generate a mobile data.

2. The mobile selling system as claimed in claim 1, wherein the server includes a central processing unit and a database electrically connected to the central processing unit.

3. The mobile selling system as claimed in claim 2, wherein the database is internally divided into a plurality of data fields, each of which includes at least one sub-field.

4. The mobile selling system as claimed in claim 1, wherein the mobile POS further includes an input unit electrically connected to the processing unit.

5. The mobile selling system as claimed in claim 1, wherein the AGPS module further includes a GPS receiver electrically connected to the wireless transceiver.

6. The mobile selling system as claimed in claim 1, wherein each of the mobile POS is assigned a unique identification code for the server to identify the mobile POS.

7. The mobile selling system as claimed in claim 4, wherein the input unit is a keyboard.

8. The mobile selling system as claimed in claim 1, wherein the display unit is a touch panel with display and control-by-touch functions.

9. A mobile selling method, comprising the steps of:
a server at a business control center identifying a plurality of mobile POS by a unique identification code assigned to each of the mobile POS, and providing each of the mobile POS with sales information corresponding to a district assigned to the mobile POS for marketing; and each of the mobile POS generating a mobile data when moving to a different position, and transmitting the mobile data via a communication interface module thereof to the server in the form of a wireless signal;
the server identifies each of the mobile POS according to the identification code corresponding to the received mobile data, reading out sales information corresponding to the identification code assigned to the mobile POS, and providing the sales information to the mobile POS; and
the mobile POS receiving the sales information via the communication interface modules and using a display unit thereof to show the received sales information.

10. The mobile selling method as claimed in claim 9, wherein the mobile data includes the geographic longitude and latitude coordinates, the current time, the speed, and the identification code of the mobile POS.

11. The mobile selling method as claimed in claim 9, wherein the server determines whether the received wireless signal is a mobile data according to the identification code corresponding to the wireless signal.

12. The mobile selling method as claimed in claim 9, wherein the communication interface module is wirelessly linked to the server.

13. The mobile selling method as claimed in claim 9, wherein the sales information includes the time, the district, the products, and the prices allowed for selling by the mobile POS.

14. A mobile selling method, comprising the steps of:
wirelessly linking a plurality of mobile POS to a server at a business control center; the server identifying each of the mobile POS by a unique identification code assigned to each of the mobile POS, providing the mobile POS with sales information corresponding to a district assigned to the mobile POS for marketing; each of the mobile POS presetting a target sale parameter at the server, and the preset target sale parameter being valid only for a predetermined period of time; when the time is over, the server summing to obtain an actual sale parameter achieved by the mobile POS within the predetermined period of time, comparing the actual sale parameter with the target sale parameter, computing the comparison to obtain a result, and giving the mobile POS a new credit value based on the computed result;
the server adjusting the sales information available for the mobile POS according to the credit value given to the mobile POS;
the server providing the mobile POS with different sales information according to the unique identification code assigned to each of the mobile POS; and
the mobile POS receiving the sales information via a communication interface module on the mobile POS and showing the received sales information via a display unit on the mobile POS.

15. The mobile selling method as claimed in claim 14, wherein the communication interface module is wirelessly linked to the server.

16. The mobile selling method as claimed in claim 14, wherein the sales information includes the time, the district, the products, and the prices allowed for selling by the mobile POS.

17. The mobile selling method as claimed in claim 14, wherein the sales information further includes the types, quantities, and amounts of products allowed for selling by the mobile POS, and the marketing district allowed for the mobile POS.

18. The mobile selling method as claimed in claim 14, wherein the credit value is increased when the actual sale parameter is equal to or higher than the target sale parameter.

19. The mobile selling method as claimed in claim 14, wherein the credit value is decreased when the actual sale parameter is lower than the target sale parameter.
